(19) United States
(12) Patent Application Publication
(10) Pub. No.: US 2018/0019554 A1
(43) Pub. Date: Jan. 18, 2018

(54) HIGH DENSITY CABLE CONNECTOR

(71) Applicant: Amphenol Corporation, Wallingford, CT (US)

(72) Inventors: WENCHU YANG, Fujian (CN); Weishun Chen, Fujian (CN)

(21) Appl. No.: 15/386,712

(22) Filed: Dec. 21, 2016

(30) Foreign Application Priority Data
Jul. 15, 2016 (CN) 201610557421.3
Jul. 15, 2016 (CN) 201620745934.2

(51) Int. Cl. H01R 24/60; H01R 13/405; H01R 13/502; H01R 43/20; H01R 43/24; H01R 107/00

(52) U.S. Cl. CPC H01R 24/60; H01R 43/205; H01R 43/24; H01R 13/405; H01R 13/502; H01R 2107/00

(57) ABSTRACT

A high density cable connector that includes a front shell configured to support first and second printed circuit boards where the first and second printed circuit boards are stacked within the front shell. Each of the first and second printed circuit boards has an interface at one end for interfacing with a mating connector and a cable termination at another end for terminating a cable. A rear shell is coupled to the front shell. The rear shell forms a mouth allowing the cable to extend therethrough. An external mounting feature extends from one of the front shell or the rear shell for mounting the cable connector to a support.

### RELATED APPLICATIONS

This application claims priority under 35 U.S.C. §119 to Chinese patent application nos. CN201610557421.3 and CN201620745934.2, both filed Jul. 15, 2016.

### FIELD OF THE INVENTION

The present application relates to a high density, high speed cable connector. In particular, the cable connector of the present application is designed to increase its transmission density while maintaining a relatively low profile and simplifying the manufacturing and assembly process of the connector.

### BACKGROUND OF THE INVENTION

Current high speed cable connectors, such as those used in servers, have insufficient transmission density and bandwidth. Additionally, the manufacturing and assembly process of the current high speed cable connectors is often complex and time consuming. Therefore, a need exists for a high density, high speed cable connector that has increased density and transmission bandwidth without significantly increasing the size and profile of the connector and while also simplifying the assembly of the connector, thereby reducing manufacturing time and costs.

### SUMMARY OF THE INVENTION

Accordingly, an exemplary embodiment of the present invention provides a high density cable connector that includes a front shell configured to support first and second printed circuit boards where the first and second printed circuit boards are stacked within the front shell. Each of the first and second printed circuit boards has an interface at one end for interfacing with a mating connector and a cable termination at another end for terminating a cable. A rear shell is coupled to the front shell. The rear shell forms a mouth allowing the cable to extend therethrough. An external mounting feature extends from one of the front shell or the rear shell for mounting the cable connector to a support. In a preferred embodiment, both the front and rear shells have an external mounting feature.

The present invention may also provide a method of assembling a cable connector, comprising the steps of terminating at least one cable to at least one printed circuit board; inserting the at least one printed circuit board with the at least cable terminated thereto through a rear end of a front shell of the cable connector until an interface of the at least one printed circuit board extends from a front end of the front shell; and after inserting the at least one printed circuit board with the at least cable terminated into the front shell, coupling a rear shell of the cable connector to the front shell by inserting the rear shell into the rear end of the front shell such that the at least one cable extends through a mouth of the rear shell. In a preferred embodiment, two printed circuit boards with cables terminated thereto, respectively, are inserted into the front shell in a stacked arrangement.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a high density cable connector in accordance with an exemplary embodiment of the present invention;

FIG. 2 is a perspective view of the high density cable connector illustrated in FIG. 1, showing a mating connector exploded from the high density cable connector;

FIG. 3 is an exploded view of the high density cable connector illustrated in FIG. 1;

FIG. 4 is a side elevational view of a front shell of the high density cable connector illustrated in FIG. 1; and

FIG. 5 is an exploded view of the high density cable connector illustrated in FIG. 1, showing a rear shell thereof exploded from the high density cable connector.

### DETAILED DESCRIPTION OF THE EXEMPLARY EMBODIMENTS

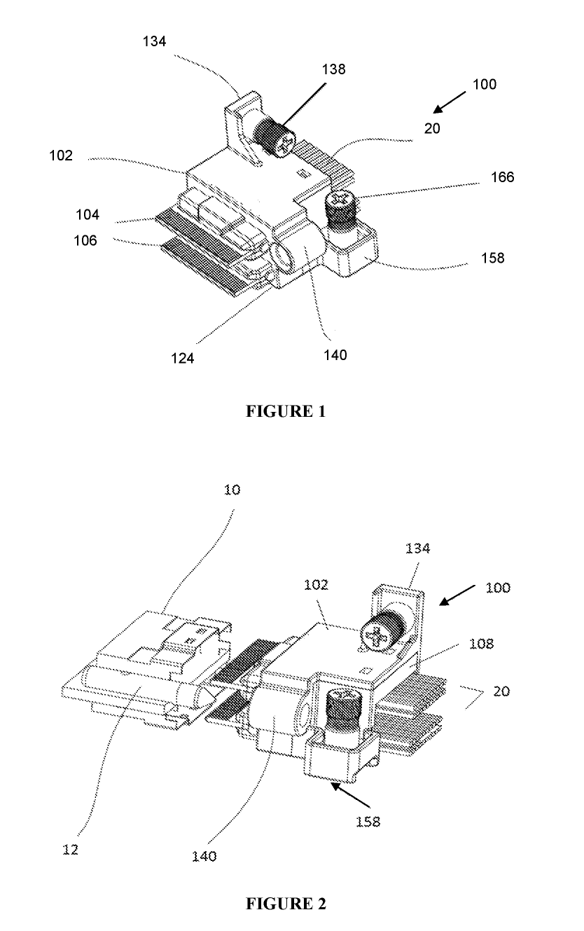

Referring to FIGS. 1-5, the present invention relates to high density, high speed cable connector 100, such as an SAS type cable connector, like an HD Mini SAS cable connector, for example. Cable connector 100 is designed to have increased density over current cable connectors while maintaining similar proportions as current cable connectors, and to have a simplified assembly process, thereby reducing manufacturing time and costs.

In general, the cable connector 100 includes a front shell 102, first and second printed circuit boards 104 and 106 supported by front shell 102, and a rear shell 108 coupled to front shell 102. By using two circuit boards 104 and 106, the density and capacity of cable connector 100 is doubled over the current cable connectors. Front shell 102 has first and second walls 112 and 114 and a side wall 116 therebetween. First and second support members 120 and 122 extend from a front end 124 of front shell 102 which receive first and second circuit boards 104 and 106, respectively, preferably in a substantially parallel stacked arrangement, as seen in FIG. 1.

Each circuit board 104 and 106 is received in front shell 102 such that an interface 126 at one end of the circuit boards extends from front face 124 for engaging a mating connector 10 (FIG. 2). Together, first and second printed circuit boards 104 and 106 can transfer speed by 16×24 G bit/s SAS signal, for example. Slideways 130 (FIG. 4) may be provided on the inner surface of the front shell's side wall 116 for supporting the sides of the circuit boards. At the end of each circuit board 104 and 106 opposite the interface 126 is a cable termination 128 for terminating a cable 20. The one or more cables 20 may be terminated to cable terminations 128 of circuit boards 104 and 106 in any known manner, such as by exposing the conductors and/or fibers thereof and soldering the same to the circuit boards.

An external mounting feature 134 is provided on front shell 102 that facilitates mounting of cable connector 100 to a support, such as any panel, backplane, and the like, used with server equipment, for example. External mounting feature 134 allows cable connector 100 to be directly mounted to the support without relying on support from the mating connector 10. External mounting feature 134 preferably extends from the front shell's first wall 112 such that it is generally aligned with side wall 116 to define a mounting plane for cable connector 100. External mounting feature 134 may be, for example, a lug having a mounting hole 136 (FIG. 4) therein for receiving a fastener 138.

A guide member 140 may be provided on front shell 102 for connecting with a corresponding guide member 12 of mating connector 10, thereby facilitating mating of the two connectors. Guide member 140 may be a bore, for example, and guide member 12 may be a pin, for example, that is received in the bore, or vice versa. Guide member 140 may be located opposite side wall 116 on front shell 102.

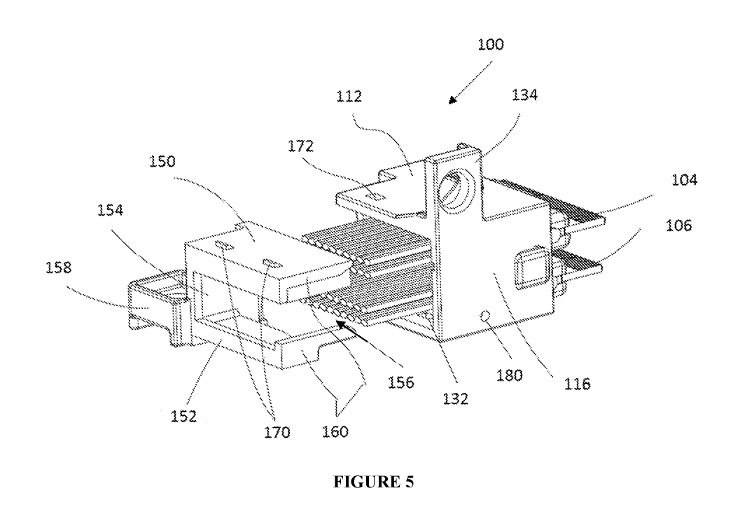

Rear shell 108 has first and second walls 150 and 152 and a side wall 154 therebetween. First and second walls 150 and 152 and side wall 154 define a mouth 156 (FIG. 5) which allows the one or more cables 20 to extend therethrough. Another external mounting feature 158 may be provided on rear shell 108 for mounting cable connector 100 to a support similar to external mounting feature 134. External mounting feature 158 preferably extends from the rear shell's side wall 154 such that it is generally aligned with second wall 152 to define another mounting plane for cable connector 100. Like external mounting feature 134, external mounting feature 158 may be, for example, a lug having a mounting hole 164 (FIG. 4) therein for receiving a fastener 166. Having more than one mounting feature allows the cable connector 100 to be mounted in various orientations as needed. In a preferred embodiment, the mounting planes of front and rear shells 102 and 108 are substantially perpendicular to one another allowing cable connector to be mounted to supports that are generally perpendicular to one another.

One or more alignment ribs 160 may be provided on rear shell 108 configured to engage corresponding one or more alignment ribs 162 of front shell 102, thereby facilitating alignment of rear shell 108 with front shell 102 when coupling the same. In a preferred embodiment, alignment ribs 160 are located at the opening of the mouth 156 of rear shell 108 and alignment ribs 162 are spaced from one another on the inner surface of the front shell's side wall 116.

One or more engagement members 170 may also be provided on rear shell 108 for engaging corresponding one or more engagement members 172 of front shell 102 for securing front and rear shells 102 and 108 together. Engagement members 170 may be, for example, an outwardly extending detent, and engagement members 172 may be holes, for example, sized to receive the detents in a snapping engagement or vice versa. In a preferred embodiment, a plurality of engagement members 170 are located on the rear shell's first and second walls 150 and 152 and a corresponding number of engagement members 172 are located on the front shell's first and second walls 112 and 114.

The simplified assembly of cable connector 100 according to the present invention includes the initial step of terminating the cables 20 to respective cable terminations 128 of printed circuit boards 104 and 106, such as by soldering. Circuit boards 104 and 106, with the cables terminated thereto, may then be inserted through the rear end 132 of front shell 102 until the interfaces 126 of the circuit boards 104 and 106 extend from the front end 124 of front shell 102, as seen in FIG. 5, such that support members 120 and 122 support the circuit boards 104 and 106, respectively, (preferably in a stacked arrangement) and the sides of the circuit boards 104 and 106 are slidably received in slideways 130. Rear shell 108 may then be coupled to front shell 102 by inserting rear shell 108 into rear end 132 of front shell 102, as seen in FIG. 5, such that the cables 20 extend through mouth 156 of rear shell 108, as seen in FIGS. 1 and 2.

Alignment ribs 160 and 162 may engage one another to facilitate alignment and insertion of rear shell 108 into the rear end 132 of front shell 102. Engagement members 170 and 172 may engage one another, preferably by a snap fit, to secure front and rear shells 102 and 108 together once rear shell 108 is inserted into the front shell's rear end 132.

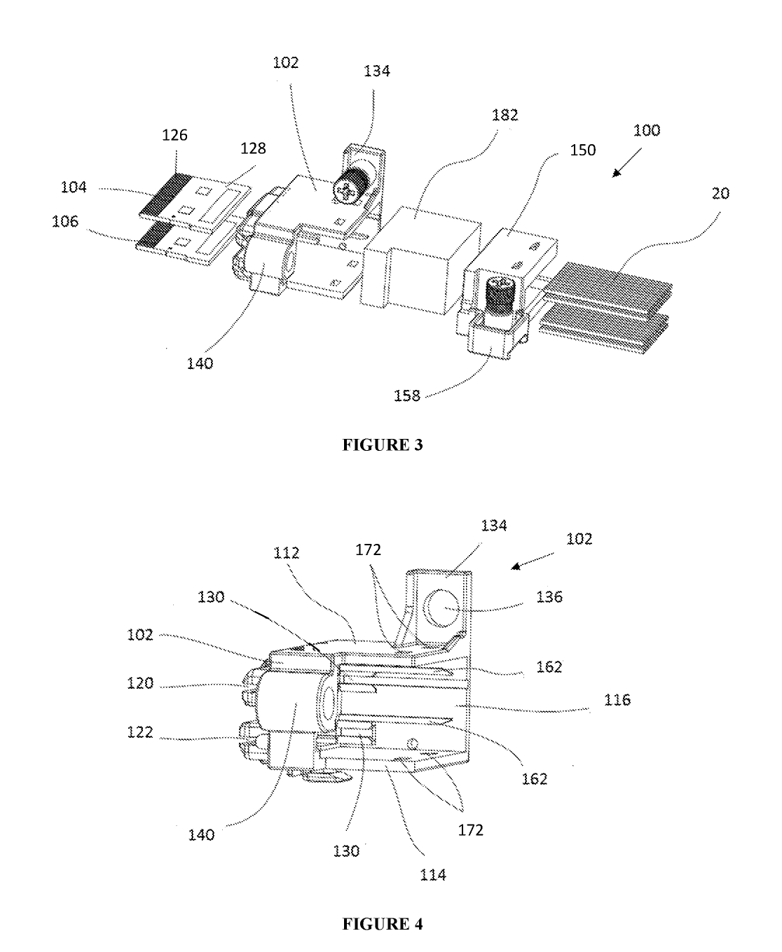

Once front and rear shells 102 and 108 are assembled together, an insulative material may be injected into the space between front and rear shells 102 and 108. Side wall 116 of front shell 102 may include an injection hole 180 (FIGS. 4 and 5) for channeling the insulative material into the space between the shells to form an insulative mold 182 (FIG. 3) that secures the printed circuit boards 104 and 106 and the terminated portions of the cables 20 into place in cable connector 100.

Cable connector 100 may be mounted to one or more supports using either external mounting feature 134 and 158 or using both features 134 and 158. Mounting of cable connector 100 is accomplished by inserting the fasteners 136 and 164 through mounting holes 138 and 166, respectively, and into the support or supports.

While a particular embodiment has been chosen to illustrate the invention, it will be understood by those skilled in the art that various changes and modifications can be made therein without departing from the scope of the invention as defined in the appended claims.

1. A high density cable connector, comprising:
a front shell configured to support first and second printed circuit boards, the first and second printed circuit boards being stacked within the front shell, each of the first and second printed circuit boards having an interface at one end for interfacing with a mating connector and a cable termination at another end for terminating a cable;
a rear shell coupled to the front shell, the rear shell forming a mouth allowing the cable to extend therethrough; and
at least a first external mounting feature extending from one of the front shell or the rear shell for mounting the cable connector to a support, the at least first external mounting feature being an outwardly extending lug with a mounting hole therein.

2. A high density cable connector according to claim 1, wherein
the first external mounting feature extends outwardly from the front shell; and
a second external mounting feature extends outwardly from the rear shell.

3. A high density cable connector according to claim 2, wherein
the first external mounting feature defines a first mounting plane; and
the second external mounting feature defines a second mounting plane, the first and second mounting planes being substantially perpendicular to one another.

4. (canceled)

5. A high density cable connector according to claim 1, wherein
the front and rear shells include corresponding alignment ribs that engage one another when coupling the front and rear shells to prevent misalignment.

6. A high density cable connector according to claim 5, wherein
the front and rear shells include corresponding engagement members that engage one another to secure the front and rear shells together.

7. A high density cable connector according to claim 1, wherein
an inner surface of the front shell includes first and second slideways that receive the sides of the first and second printed circuit boards, respectively.

8. A high density cable connector according to claim 1, wherein
the front shell includes a guide member for engaging a corresponding guide member of the mating connector.

9. A high density cable connector according to claim 1, further comprising
an insulative mold provided in a space between the front and rear covers.

10. A high density cable connector according to claim 9, wherein
the front shell includes an injection hole for channeling an injection molding insulation material into the space between the front and rear covers to form the insulative mold.

11. A method of assembling a cable connector, comprising the steps of:
terminating at least one cable to at least one printed circuit board;
inserting the at least one printed circuit board with the at least cable terminated thereto through a rear end of a front shell of the cable connector until an interface of the at least one printed circuit board extends from a front end of the front shell; and
after inserting the at least one printed circuit board with the at least cable terminated into the front shell, coupling a rear shell of the cable connector to the front shell by inserting the rear shell into the rear end of the front shell such that the at least one cable extends through a mouth of the rear shell.

12. A method according to claim 11, further comprising the step of
terminating a second cable to a second printed circuit board; and
inserting the second printed circuit board with the second cable terminated thereto through the rear end of the front shell until an interface of the second printed circuit board extends from the front end of the front shell.

13. A method according to claim 12, further comprising the step of
inserting the at least one printed circuit board and the second print circuit board through the rear end of the front shell such that the printed circuit boards are in a stacked arrangement inside of the front shell.

14. A method according to claim 12, further comprising the step of
sliding the at least one printed circuit board and the second printed circuit board through respective slideways on an inner surface of the front shell when inserting the printed circuit boards into the front shell.

15. A method according to claim 12, further comprising the step of
aligning the front and rear shells by engaging corresponding alignment ribs of the front and rear shells, respectively.

16. A method according to claim 12, further comprising the step of
snap fitting the rear shell to the rear end of the front shell.

17. A method according to claim 12, further comprising the step of
injecting insulative material into a space between the front and rear covers to form an insulative mold therein.

18. A method according to claim 12, wherein
each of the steps terminating the at least one cable and the second cable includes soldering conductors or fibers of the cables to the at least one printed circuit board and the second printed circuit board, respectively.

19. A method according to claim 12, wherein
an external mounting feature extends from one of the front shell or the rear shell for mounting the cable connector to a support.

20. A method according to claim 19, further comprising the step of
coupling a fastener to the external mounting feature.

21. A high density cable connector, comprising:
a front shell configured to support first and second printed circuit boards, the first and second printed circuit boards being stacked within the front shell, each of the first and second printed circuit boards having an interface at one end for interfacing with a mating connector and a cable termination at another end for terminating a cable; and
a rear shell coupled to the front shell, the rear shell having opposing first and second walls and a side wall extending therebetween, the first, second, and side walls forming a mouth allowing the cable to extend therethrough,
wherein the mouth is open at a side of the rear shell opposite the side wall of the rear shell and wherein the front shell includes an injection hole at a side wall thereof.
